(19) United States
(12) Patent Application Publication
(10) Pub. No.: US 2011/0203738 A1
(43) Pub. Date: Aug. 25, 2011

(54) DEVICE FOR BUILDING A TIRE CARCASS FOR A VEHICLE TIRE

(75) Inventors: STEFAN LINNE, WEDEMARK (DE); KARL-HEINZ PAWLIK, HANNOVER (DE)

(73) Assignee: CONTINENTAL REIFEN DEUTSCHLAND GMBH, HANNOVER (DE)

(21) Appl. No.: 13/099,727

(22) Filed: May 3, 2011

Related U.S. Application Data
(63) Continuation of application No. PCT/EP2009/063442, filed on Oct. 15, 2009.

(30) Foreign Application Priority Data
Nov. 10, 2008 (DE) 10 2008 037 535.7

(51) Int. Cl. B29D 30/26

(52) U.S. Cl. 156/416

(57) ABSTRACT

A device for constructing a carcass for a vehicle tire. In order to provide a device with which the core centering devices can be expanded variably in diameter, wherein the core centering devices can be used at the same time for producing small tire dimensions, and with which at the same time the diameter of the diaphragm supports can be moved by a motor. The bladder support on the side of the movement box is connected to the shaft of the movement box in a fixed manner, with the axial distance for determining the carcass width of the vehicle tire to be produced between the diaphragm support and building drum being defined by positioning of the movement box in the axial direction. The bladder support on the side of the spindlebox is movably attached to the shaft. The axial distance for determining the carcass width of the vehicle tire to be produced between the bladder support and the building drum is defined by positioning in the axial direction.

### CROSS-REFERENCE TO RELATED APPLICATION

This application is a continuation, under 35 U.S.C. §120, of copending international application No. PCT/EP2009/063442, filed Oct. 15, 2009, which designated the United States; this application also claims the priority, under 35 U.S.C. §119, of German patent application No. DE 10 2008 037 535.7, filed Nov. 10, 2008; the prior applications are herewith incorporated by reference in their entirety.

### BACKGROUND OF THE INVENTION

### Field of the Invention

The invention relates to a device for building a tire carcass for a vehicle tire.

In tire production, building drums are used for producing the tire carcass. On such building drums, individual tire building components in the form of rubber plies with reinforcing elements are wound and assembled. In one of the method steps, the tire cores with bead fillers are positioned at the appropriate place, the insert ends then being wrapped around these tire cores. Subsequently, the tire carcass is removed from the building drum and further processed on a further device.

One disadvantage of conventional building drums for producing tire carcasses is that the core centering devices are not suitable for small tire dimensions. One of the reasons for this is that the minimum diameter of the centering device is governed by the maximum diameter of the shaft on the side where the movement box is located. A so-called bladder support, which is, inter alia, pneumatically driven, is arranged on the end of the shaft of the movement box. The bladder support itself is connected by means of pneumatic lines to lines in the movement box, these pneumatic lines being arranged around the shaft of the movement box. These pneumatic lines reduce the minimum diameter that can be achieved by the core centering device. Therefore, conventional building drums for the tire carcass cannot be used for producing tires with a tire dimension of 13 inches or less.

### SUMMARY OF THE INVENTION

It is accordingly an object of the invention to provide a device for building a vehicle tire carcass which overcome the above-mentioned disadvantages of the heretofore-known devices and methods of this general type and with which the core centering devices are variably expandable in diameter and which can be used at the same time for producing small tire dimensions.

With the foregoing and other objects in view there is provided, in accordance with the invention, a device for building a tire carcass for a vehicle tire, the device comprising:

a building drum for winding a tire carcass, the building drum having two sides and rotating about an axis;

a first shaft for rotating the building drum;

a respective bladder support on each of the two sides of the building drum, each bladder support having an inflatable bladder for wrapping around inserts;

a movement box with a second shaft;

wherein the bladder support, on a side of the building drum facing towards the movement box, is fixedly connected to the second shaft, and an axial distance between the bladder support and the building drum, for determining a carcass width of the vehicle tire to be produced, is attained by positioning the movement box in an axial direction.

In other words, the objects of the invention are achieved in that the bladder support on the side where the movement box is located is fixedly connected to the shaft of the movement box, and the axial distance between the bladder support and the building drum, for fixing the carcass width of the vehicle tire to be produced, is obtained by way of positioning the movement box in the axial direction.

One advantage of the invention can be seen in particular in that this structural design reduces the effective diameter of the shaft of the movement box. The bladder support arranged at the end of the shaft is now no longer moved in its axial position by means of a pneumatic or motorized drive. As a result, there is no need for the pneumatic lines that are arranged around the shaft of the movement box in the case of the conventional devices. The axial position of the bladder support on the side where the movement box is located is now set by the positioning of the movement box. A further advantage is that adequate space within the structure is now available to let the bladder supports expand with a motorized drive. The modification in the structural design therefore enables the device likewise to produce tire carcasses for small tire dimensions. These small tire dimensions are 13-inch tires or even smaller tire dimensions. A further advantage is that the device as a whole is more flexible and quicker in the case of a change of tire dimensions. Furthermore, the dimension changing times are shorter.

In accordance with an advantageous development of the invention, an extendable ram is arranged at the shaft end of the second shaft (i.e., the shaft on the movement box side) for coupling onto the drive shaft of the building drum. The distance between the shaft ends of the shaft on the side where the movement box is located and the drive shaft is bridged by the ram. The ram likewise serves the purpose of effectively coupling the two shaft ends to each other.

In a further advantageous development of the invention, the extending mechanism of the ram is pneumatically operated. This ensures that, when there are different distances between the two shaft ends, there is always a uniformly high pressing pressure that couples the two shaft ends to one another.

In accordance with another feature of the invention, the ram has an end toothing for engagement in the opposite shaft end of the drive shaft for the building drum. The end toothing ensures an effective force transmission or torque transmission between the two shaft ends.

In a further advantageous development of the invention, the bladder support on the side where the movement box is located is increased or reduced in diameter radially by a motorized drive. This allows the bladder support to be expanded with high precision into specific positions.

In accordance with again another feature of the invention, the movement box is driven movably in the axial direction by a spindle. By means of the spindle drive, the movement box can be moved with high precision into a specific axial position, this axial position fixing the distance between the bladder support and the building drum.

In accordance with yet another feature of the invention, the movement box is positioned in the axial direction at a defined distance from the building drum by a motorized drive. With the motorized drive, simple moving of the movement box in the axial direction is possible.

In a further advantageous development of the invention, the device has two core centering devices, which in the basic position are arranged coaxially around the second shaft of the movement box. The arrangement of the two core centering devices coaxially around the second shaft of the movement box ensures quick and effective insertion of the prefabricated tire cores into the device.

In accordance with a further feature of the invention, the diameter of the core centering devices can be variably set and can be adapted to the tire dimension to be produced as well as to the diameter of the tire cores. This allows the device to be used for producing tires with different tire dimensions, the change-over times to another tire dimension being very short.

In accordance with again a further feature of the invention, the core centering devices can be reduced to a diameter whereby the receiving of tire cores for 13-inch tires is made possible. In the case of conventional devices for producing tire carcasses, the production of tire carcasses with correspondingly small tire dimensions was not possible. In the instant case, the term “smaller tires” or “smaller inch tires” are defined as 13-inch or smaller tires.

In a further advantageous development of the invention, the bladder support on the side where the drive shaft of the building drum is located is moved in the axial direction by a motorized drive, whereby the distance between this bladder support and the building drum is fixed. This distance fixes, inter alia, the width of the tire carcass, this width varying with different tire dimensions or types of tire.

In accordance with a concomitant feature of the invention, the diameter of the bladder supports on the side where the drive shaft of the building drum is located is adjustable by a motorized drive. This allows the bladder support to be moved with high precision into a specific position.

Other features which are considered as characteristic for the invention are set forth in the appended claims.

Although the invention is illustrated and described herein as embodied in a device for building a tire carcass for a vehicle tire, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a basic diagram of the device according to the invention; and

FIG. 2 is a basic diagram of the right-hand side of the device, illustrated to a slightly larger scale.

### DETAILED DESCRIPTION OF THE INVENTION

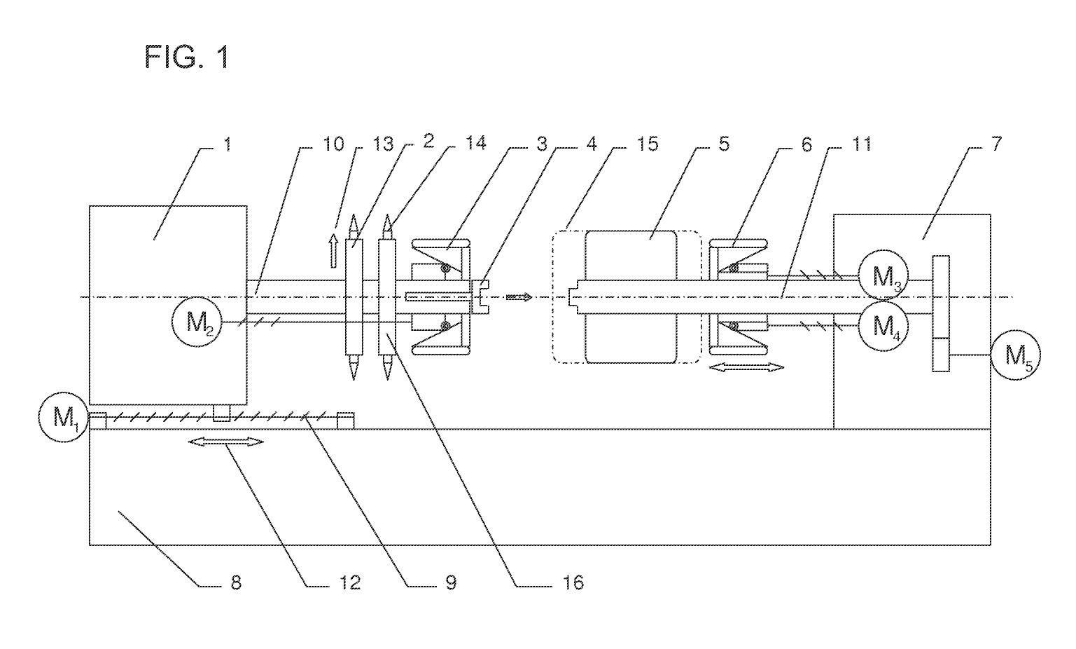

Referring now to the figures of the drawing in detail and first, particularly, to FIG. 1 thereof, there is shown the device according to the invention in a basic position. The device comprises a building drum or carcass drum 5, which is arranged rotatably on a drive shaft 11. The drive shaft 11, which is referred to here as a first shaft 11, is mounted rotatably in a spindle box 7 and is driven by way of a motor M₅. The dashed line 15 shows a possible wider building drum, which could likewise be arranged on the drive shaft 11, for example for larger tire dimensions. Arranged on the two sides of the building drum 5 are a left bladder support 3 and a right bladder support 6. The bladder supports may also be referred to as diaphragm supports. The right bladder support 6 is moved in its axial position along the shaft 11 by means of the motor M₃. The axial position of the bladder support 6 is dependent on the tire carcass that is respectively required. A diameter adjustment of the bladder support in the radial direction 13 takes place by means of the motor M₄. The bladder supports 3 and 6 are provided on their outer circumference with inflatable bladders, which, inter alia, wrap the insert ends around the tire cores. The left bladder support 3 is arranged in a fixed manner on the shaft end of a second shaft 10 of a movement box 1. The bladder support 3 is, for example, fixedly screwed to the shaft end of the second shaft 10. The shaft 10 is mounted freely rotatably in the movement box 1. The movement box 1 is driven in the axial direction 12 by the spindle 9. The drive in the axial direction 12 of the movement box 1 takes place by means of the motor M₁. The movement box 1 and the spindle box 7 are arranged on the under-bed 8.

As mentioned, the device is shown in its basic position. In a first step, the prefabricated tire cores 14 with bead fillers are positioned on the core centering devices 2. The core centering devices are configured such that they are variable in their diameter and are likewise suitable for tire cores for 13-inch tires. In a further step, the movement box 1 is moved in the axial direction toward the spindle box, so that the bladder support 3 is positioned at a predetermined distance from the building drum 5. It is generally moved to within the same distance as has been set on the opposite side of the building drum 5 between the right bladder support 6 and the building drum 5. As the next step, the ram 4 in the form of a shaft coupling is pneumatically extended out of the shaft end of the second shaft 10, so that the ram 4 engages in the opposite end of the drive shaft 11 and couples the two shaft ends to each other. In a further method step, the right core centering device moves up to the right side of the machine between bladder support 6 and spindle box 7. This is followed by placement of the carcass plies onto the building drum 5 and the bladder supports 3 and 6. Once the tire shoulder has been formed, the tire cores are positioned and placed at the appropriate positions of the tire carcass. In a further step, the insert ends are wrapped around the tire cores. This wrapping operation takes place substantially by inflating the bladders that are arranged on the bladder supports 3 and 6. In a further step, the bladder supports expand and form with the carcass drum a largely cylindrical surface, on which the bead reinforcer and the side strips are placed. In a further method step, the movement box is moved back into its basic position and the left bladder support is moved axially away from the drum to make space for the rolling in of the bead reinforcer and the side strips around the core. And then the finished tire carcass is removed. The tire carcass is then passed on to a further device, where the further building of the tire takes place.

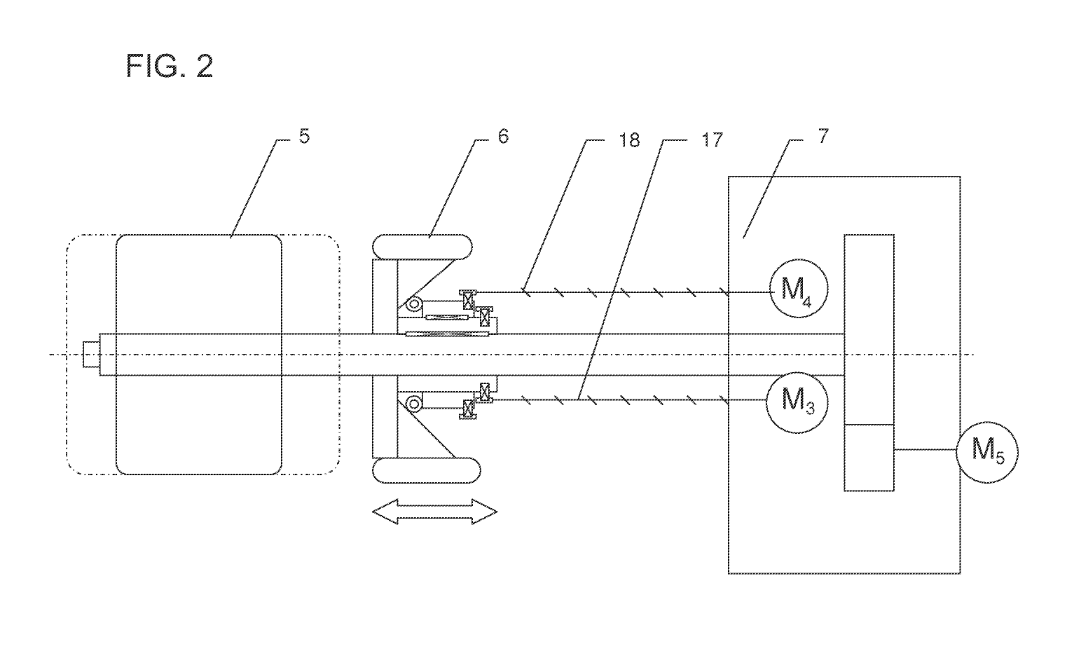

FIG. 2 shows a basic diagram of the right side of the machine in FIG. 1. It substantially depicts the carcass drum 1, the right bladder support 6 and the spindle box 7. The expanding or diameter adjustment of the bladder support 6 in the radial direction takes place by way of the motorized drive M₄ and the spindle 18. The motor drive M₄ is decoupled from the rotational movement of the bladder support 6 by way of a rotary bearing. The axial adjustment or the axial movement of the bladder support 6 in the axial direction 12 takes place by means of the motorized drive M₃ and the spindle 17.

1. A device for building a tire carcass for a vehicle tire, the device comprising:
a building drum for winding a tire carcass, said building drum having two sides and rotating about an axis;
a first shaft for rotating said building drum;
a respective bladder support on each of said two sides of said building drum, each bladder support having an inflatable bladder for wrapping around inserts;
a movement box with a second shaft;
wherein said bladder support, on a side of said building drum facing towards said movement box, is fixedly connected to said second shaft, and an axial distance between said bladder support and said building drum, for determining a carcass width of the vehicle tire to be produced, is attained by positioning said movement box in an axial direction.

2. The device according to claim 1, which comprises an extendable ram disposed at a shaft end of said second shaft of said movement box for coupling onto said first shaft driving said building drum.

3. The device according to claim 2, wherein said ram has a pneumatically operated extending mechanism.

4. The device according to claim 2, wherein said ram has an end toothing for engagement in a corresponding opposite shaft end of said first shaft driving said building drum.

5. The device according to claim 1, which comprises a motorized drive for radially increasing or reducing a diameter of said bladder support on the side of said movement box.

6. The device according to claim 1, which comprises a spindle configured to displace said movement box in the axial direction.

7. The device according to claim 1, which comprises a motorized drive for positioning said movement box in the axial direction at a defined distance from said building drum.

8. The device according to claim 1, which comprises two core centering devices which, in a basic position thereof, are arranged coaxially around said second shaft of said movement box.

9. The device according to claim 8, wherein said core centering devices have a variably adjustable diameter and are adaptable to a tire dimension to be produced and to a diameter of the tire cores.

10. The device according to claim 8, wherein said core centering devices are configured to be reduced to a diameter suitable for receiving tire cores for smaller inch tires.

11. The device according to claim 1, which comprises a motorized drive for moving said bladder support on the side of said building drum where said first shaft for driving said building drum is located in the axial direction, wherein a spacing distance between said bladder support and said building drum is fixed.

12. The device according to claim 1, which comprises a motorized drive configured for adjusting a diameter of said bladder support on the side of said building drum where said first shaft for driving said building drum is located.
